(19) United States
(12) Patent Application Publication
(10) Pub. No.: US 2018/0138480 A1
(43) Pub. Date: May 17, 2018

(54) CELL POUCH HAVING EXCELLENT FORMABILITY

(71) Applicant: YOULCHON CHEMICAL CO., LTD., Seoul (KR)

(72) Inventors: Hee Sik HAN, Gunpo-si (KR); Kyung Chan KIM, Ansan-si (KR); Jong Hyub PARK, Siheung-si (KR)

(73) Assignee: YOULCHON CHEMICAL CO., LTD., Seoul (KR)

(21) Appl. No.: 15/627,858

(22) Filed: Jun. 20, 2017

(30) Foreign Application Priority Data
Nov. 14, 2016 (KR) 10-2016-0151123

(51) Int. Cl. H01M 2/12; C08G 69/00; C08G 63/183; H01M 10/04; H01M 2/08

(52) U.S. Cl. CPC H01M 2/1288; C08G 69/00; H01M 2/022; H01M 10/0422; H01M 2/08; C08G 63/183

(57) ABSTRACT

The present specification discloses a cell pouch having excellent formability, which includes a high elongation nylon film. When the high elongation nylon film is stretched in a machine direction (MD), an increment of a tensile strength value with respect to an increment of an elongation value (an increment of tensile strength/an increment of elongation) increasing from 6.7% to 100% is more than 0.04 and less than 0.05, and when the high elongation nylon film is stretched in a transverse direction (TD), an increment of a tensile strength value with respect to an increment of an elongation value increasing from 6.7% to 100% is more than 0.06 and less than 0.08.

### CROSS-REFERENCE TO RELATED APPLICATION

This application claims the priority of Korean Patent Application No. 10-2016-151123, filed on Nov. 14, 2016, and all the benefits accruing therefrom under 35 U.S.C. § 119, the contents of which in its entirety are herein incorporated by reference.

### BACKGROUND

### 1. Field

The present specification discloses a cell pouch having excellent formability, which includes a high elongation nylon film.

[Description of the National Support Research and Development]

This study is made by the support of the Korea Institute of Energy Research of the Ministry of Knowledge Economy, Republic of Korea under the supervision of Samsung SDI Co., Ltd., and the project name is ‘Demonstration of 10 kWh-Grade LIB Power Storage System’ (Project identification No.: 2010T100200295).

### 2. Description of the Related Art

In general, cells such as secondary batteries are embedded in a metal can. For the metal can, aluminum (Al) is usually used, and the metal can is manufactured in the form of a cylinder or a polygon (a rectangular parallelepiped, and the like).

However, the metal can has a limitation in that the shape of the cell itself is determined by the shape of the metal can due to the hard outer wall. In order to overcome the limitation, flexible cell pouches have been developed and used, and in general, the flexible cell pouches have been manufactured with a multi-layered structure in consideration of gas barrier properties, electrolytic solution resistance, heat adhesive property, and the like.

A cell pouch generally includes a sealant layer, a metal layer for a gas barrier (for example, an aluminum metal layer), and an outer layer (for example, a nylon resin layer) as an outermost layer.

The sealant layer is positioned in the innermost portion of the cell pouch and is brought into contact with contents, that is, a cell. The sealant layer usually includes a polypropylene-based resin in order to stabilize heat resistance and cold resistance of a battery. The metal layer is provided for blocking gas from entering the cell pouch together with mechanical strength, and an aluminum thin film (Al foil) is usually used. Moreover, the outer layer is provided for protecting the metal layer, and a polyethylene terephthalate (PET) resin and/or a nylon resin are/is usually used in consideration of heat resistance, pinhole resistance, abrasion resistance, and the like.

A cell pouch according to the related art has a problem in that the formability deteriorates during the processing. Specifically, the cell pouch is processed while being folded in the form of a pouch or a box as described above in order to package the cell, and in this case, a polyethylene terephthalate (PET) constituting the outer layer has such a low elongation that the folding processability deteriorates. Accordingly, there is a problem in that the polyethylene terephthalate is not easily formed into a pouch.

Further, the polyethylene terephthalate (PET) constituting the outer layer has a problem in that the abrasion resistance, scratch resistance, chemical resistance, and the like are weak, and the durability deteriorates. In particular, scratches are easily generated on the surface of the polyethylene terephthalate (PET), and it is difficult to recover the generated scratches. Accordingly, in manufacturing a cell pouch, in most cases, a nylon resin layer and a polyethylene terephthalate (PET) layer are sequentially laminated and formed on a gas barrier layer in order to strengthen the durability, and the like, and even in this case, there is a problem in that the formability, abrasion resistance, scratch resistance, and the like are weak.

### REFERENCES OF THE RELATED ART

### Patent Documents

(Patent Document 1) Korean Patent Application Laid-Open No. 10-2014-0087602.

### SUMMARY

In an aspect, the present specification is directed to providing a cell pouch having excellent formability by using a high elongation nylon film having improved elongation and homeostasis as compared to the constitution of a cell pouch in the related art.

In an aspect, a technology disclosed in the present specification provides a cell pouch having excellent formability, the cell pouch including: a sealant layer; a metal layer formed on the sealant layer; and an outer layer formed on the metal layer, in which the outer layer includes an elongation nylon film, and when the elongation nylon film is subjected to a tensile test under conditions of a sample width of 15 mm, a distance between gauge marks of 30 mm, and a measurement speed of 200 mm/min, a graph for a tensile strength value with respect to an elongation value satisfies the following conditions in a case where an elongation (%) is defined as “x” and a tensile strength (kgf) is defined as “y”:

(i) when the film is stretched in a machine direction (MD), a slope “a” value, which is an increment of a tensile strength value with respect to an increment of an elongation value (an increment of tensile strength/an increment of elongation) increasing from 6.7% to 100%, is more than 0.04 and less than 0.05; and

(ii) when the film is stretched in a transverse direction (TD), a slope “c” value, which is an increment of a tensile strength value with respect to an increment of an elongation value (an increment of tensile strength/an increment of elongation) increasing from 6.7% to 100%, is more than 0.06 and less than 0.08.

In an exemplary embodiment, the slope “a” value may be 0.042≤a≤0.049.

In another exemplary embodiment, the slope “a” value may be 0.044≤a≤0.049.

In another exemplary embodiment, the slope “c” value may be 0.065≤c≤0.078.

In another exemplary embodiment, the slope “c” value may be 0.07≤c≤0.078.

In another exemplary embodiment, when a graph of the tensile strength value with respect to the elongation value is “y=ax+b” during the stretch in the MD, a y intercept “b” value at an elongation of 6.7% may be 2<b<3 or 3.9<b<4.5, and when a graph of the tensile strength value with respect to the elongation value during the stretch in the TD is “y=cx+d”, a y intercept “d” value at an elongation of 6.7% may be 0.1<d<2.5.

In another exemplary embodiment, the y intercept “b” value may be 2.5<b<3 or 3.9<b<4.3.

In another exemplary embodiment, the y intercept “b” value may be 2<b<3.

In another exemplary embodiment, the y intercept “d” value may be 0.5<d<2.5.

In another exemplary embodiment, the y intercept “d” value may be 0.5<d<1.5.

In another exemplary embodiment, in the nylon film, a stretch ratio in the MD and a stretch ratio in the TD may be each 2.8 times to 4.0 times, a difference between a stretch ratio in the MD and a stretch ratio in the TD may be 0.1 or more, and the stretch ratio in the MD may be smaller than the stretch ratio in the TD.

In another exemplary embodiment, in the nylon film, the stretch ratio in the MD may be 2.8 times to 3.3 times, and the stretch ratio in the TD may be 3.0 times to 3.5 times.

In an exemplary embodiment, in the nylon film, a difference between the stretch ratio in the MD and the stretch ratio in the TD may be 0.2 to 0.8.

In another aspect, a technology disclosed in the present provides a cell pouch including: a sealant layer; a metal layer formed on the sealant layer; and an outer layer formed on the metal layer, in which the outer layer includes a nylon film, and in the nylon film, a stretch ratio in the MD and a stretch ratio in the TD are each 2.8 times to 4.0 times, a difference between the stretch ratio in the MD and the stretch ratio in the TD is 0.1 or more, and the stretch ratio in the MD is smaller than the stretch ratio in the TD.

In an exemplary embodiment, in the nylon film, the stretch ratio in the MD may be 2.8 times to 3.3 times, and the stretch ratio in the TD may be 3.0 times to 3.5 times.

In another exemplary embodiment, in the nylon film, a difference between the stretch ratio in the MD and the stretch ratio in the TD may be 0.2 to 0.8.

In another exemplary embodiment, in the nylon film, a heat setting temperature after stretching the film may be 150 to 218° C.

In still another aspect, a technology disclosed in the present specification provides a secondary battery including the cell pouch.

In an aspect, a technology disclosed in the present specification has an effect of providing a cell pouch having excellent formability by using a high elongation nylon film having improved elongation and homeostasis as compared to the constitution of a cell pouch in the related art.

### BRIEF DESCRIPTION OF THE DRAWINGS

FIG. 1 shows a graph of a tensile strength (kgf) value with respect to an elongation (%) value when a nylon film is subjected to a tensile test in the MD according to a test example of the present specification.

FIG. 2 shows a graph of a tensile strength (kgf) value with respect to an elongation (%) value when a nylon film is subjected to a tensile test in the TD according to a test example of the present specification.

FIG. 3 shows a schematic view of a test apparatus during a formability test of a cell pouch according to a test example of the present specification.

### DETAILED DESCRIPTION

Hereinafter, the present disclosure will be described in detail.

In the present specification, the “cell” means a battery, and has the widest meaning which all includes various batteries such as a secondary battery such as a lithium ion battery and a lithium polymer battery, or a portable storage battery.

In the present specification, the “cell pouch” is a cell pouch in which cell constituent elements such as a positive electrode, a negative electrode, and a separator are received while being impregnated in an electrolytic solution, and has the widest meaning which includes all the cell pouches in which a film having a laminated structure is processed into a pouch form or a box form, and the like in consideration of gas barrier properties, electrolytic solution resistance, heat adhesive property, and the like in order to receive the cell constituent elements.

In the present specification, the “formability” means the form maintaining property when a cell pouch is processed into a predetermined shape (box, and the like).

When one layer or member is disposed “on one surface of” or “on” another layer or member in the present specification, this means including not only a case where the one layer or member is brought into contact with another member, but also a case where still another layer or still another member is present between the two layers or the two members.

The cell pouch according to an exemplary embodiment of the present specification has a multi-layered structure which has at least three or more layers including a sealant layer; a metal layer; and an outer layer, which are sequentially laminated. Each layer of the cell pouch may be constituted by appropriately adopting a layer structure, a constituent component, and the like typically used for adhesive property, heat resistance, cold resistance, corrosion resistance, insulation and/or formability, and the like.

Cells are received (embedded), and then adhered (heat fused) by heat, so that the sealant layer imparts sealing property, and may include a sealing resin for heat adhesion. The sealant layer is brought into contact with cell constituent elements, and thus may be constituted by appropriately adopting a layer constitution typically used in order to impart insulation, electrolytic solution resistance and/or high heat adhesive strength (sealing property).

The sealing resin is not limited as long as the sealing resin may be fused (heat adhered) by heat, and may be preferably a resin having insulation, electrolytic solution resistance and/or cold resistance, and the like together with heat adhesive property. The sealing resin may be preferably selected from a low-melting point resin capable of being heat-fused at low temperature.

In an exemplary embodiment, the sealing resin may use one or more selected from, but not limited to, a polyolefin-based resin such as a polypropylene (PP)-based or polyethylene (PE)-based resin, a co-polymer or derivative thereof, ethylenevinylacetate (EVA), and the like. Further, the sealing resin is a co-polymer or a ter-polymer, and may be selected from, for example, an ethylene/propylene co-polymer or a ter-polymer (3-membred co-polymer) of ethylene/propylene/butadiene, and the like.

In an exemplary embodiment, the sealing resin may be a polypropylene (PP)-based resin. As the sealing resin, specifically, one or more polypropylene-based resins selected from a homo-polypropylene (homo-PP), a polypropylene co-polymer (PP co-polymer), and a polypropylene ter-polymer (PP ter-polymer), and the like may be used alone, or a mixture of a polyethylene (PE)-based resin or ethylenevinylacetate (EVA), and the like with the polypropylene sealing resin may be used. The polypropylene (PP)-based resin has not only good heat adhesive property (sealing property) and insulation, but also excellent mechanical properties such as tensile strength, rigidity, and surface hardness and chemical resistance such as electrolytic solution resistance, and thus may be usefully utilized.

The thickness of the sealant layer is not particularly limited, but the sealant layer may have a thickness of, for example, 5 μm to 150 μm, 10 μm to 100 μm, or 10 μm to 80 μm. The sealant layer may have a thickness of preferably 20 μm or more, specifically 20 μm to 70 μm, and more preferably 30 μm to 60 μm for good heat adhesive strength (sealing property).

The metal layer is not limited as long as the metal has gas barrier property. The metal layer may block external moisture or air and gas generated therein from entering the cell pouch.

In an exemplary embodiment, the metal layer may include one or more selected from a metal thin film and a metal deposition layer, and the like. In this case, as the metal thin film, a metal foil, and the like may be used, and the metal deposition layer may be vacuum deposited and formed on a separate plastic film, for example, a film of polyethylene terephathalate (PET), polyethylene (PE) or polypropylene (PP), and the like.

Examples of a metal constituting the metal layer, specifically, a metal constituting the metal thin film or the metal deposition layer include one or more (a single metal or a mixture of the single metals) selected from the group consisting of, but not limited to, aluminum (Al), iron (Fe), copper (Cu), nickel (Ni), tin (Sn), zinc (Zn), indium (In) and tungsten (W), and the like, or an allow of two or more selected therefrom, and the like. Preferably, the metal may be selected from aluminum (Al) or an aluminum alloy (Al alloy). Furthermore, as the metal layer, it is possible to use a metal layer which is subjected to surface treatment with phosphoric acid or chromium, and the like, or subjected to fin unevenness treatment for corrosion resistance.

In an exemplary embodiment, the metal layer may have a thickness of 1 μm to 60 μm, 5 μm to 50 μm, 10 μm to 40 μm, or 10 μm to 30 μm.

The outer layer may include a resin which may protect a metal layer and has characteristics such as, for example, heat resistance, cold resistance, pinhole resistance, insulation, solvent resistance and/or formability (form maintaining property when a flexible cell pouch is processed into a predetermined shape (box, and the like)) together with abrasion resistance.

The outer layer includes a nylon film, and may include one or more resins selected from a polyethylene terephthalate (PET) resin and a polyolefin-based resin, and the like. Examples of the polyolefin-based resin include polyethylene (PE) and polypropylene (PP). Preferably, the outer layer may be constituted as a composite layer of a nylon resin layer and a polyethylene terephthalate (PET) layer.

When the nylon film is subjected to a tensile test under conditions of a sample width of 15 mm, a distance between gauge marks of 30 mm, and a measurement speed of 200 mm/min, a graph for a tensile strength value with respect to an elongation value satisfies the following conditions in a case where an elongation (%) is defined as “x” and a tensile strength (kgf) is defined as “y”:

(i) when the film is stretched in a machine direction (MD), a slope “a” value, which is an increment of a tensile strength value with respect to an increment of an elongation value (an increment of tensile strength/an increment of elongation) increasing from 6.7% to 100%, is more than 0.04 and less than 0.05; and

(ii) when the film is stretched in a transverse direction (TD), a slope “c” value, which is an increment of a tensile strength value with respect to an increment of an elongation value (an increment of tensile strength/an increment of elongation) increasing from 6.7% to 100%, is more than 0.06 and less than 0.08.

In an exemplary embodiment, it may be preferred that the slope “a” value is 0.042≤a≤0.049, specifically 0.043≤a≤0.049 or 0.044≤a≤0.049 in terms of improvement in formability of the cell pouch.

In an exemplary embodiment, it may be preferred that the slope “c” value is 0.065≤a≤0.078, specifically 0.068≤a≤0.078 or 0.07≤a≤0.078 in terms of improvement in formability of the cell pouch.

In an exemplary embodiment, when a graph of the tensile strength value with respect to the elongation value is “y=ax+b” during the stretch in the MD, a y intercept “b” value at an elongation of 6.7% may be 2<b<3 or 3.9<b<4.5, and when a graph of the tensile strength value with respect to the elongation value during the stretch in the TD is “y=cx+d”, a y intercept “d” value at an elongation of 6.7% may be 0.1<d<2.5. Accordingly, the y intercept value is so high that there are advantages in that a problem in that cracks may occur is prevented due to the strong initial withstanding force, and a cell pouch is elongated even at a low force, and thus may be easily formed.

In an exemplary embodiment, the y intercept “b” value may be preferably 2.5<b<3 or 3.9<b<4.3 in terms of improvement in formability of the cell pouch.

In an exemplary embodiment, the y intercept “b” value may be 2.7<b<3 or 3.9<b<4.1.

In an exemplary embodiment, the y intercept “b” value may be preferably 2<b<3, specifically, 2.5<b<3 or 2.7<b<3 in terms of improvement in formability of the cell pouch.

In an exemplary embodiment, the y intercept “d” value may be preferably 0.5<d<2.5, specifically, 1<d<2.5 or 1.1<d<2.5 in terms of improvement in formability of the cell pouch.

In another exemplary embodiment, the y intercept “d” value may be 0.5<d<2.3, specifically, 1<d<2.3 or 1.1<d<2.3.

In another exemplary embodiment, the y intercept “d” value may be 0.5<d<2.3, specifically, 1<d<2.3 or 1.1<d<2.3.

In an exemplary embodiment, the nylon film may be manufactured with a stretch ratio in the MD and a stretch ratio in the TD each being 2.8 times to 4.0 times, 2.8 times to 3.8 times, 2.8 times to 3.5 times, 2.8 times to 3.3 times, 2.8 times to 3.0 times, 3.0 times to 4.0 times, 3.0 times to 3.8 times, 3.0 times to 3.5 times, 3.0 times to 3.3 times, 3.2 times to 4.0 times, 3.2 times to 3.8 times, or 3.2 times to 3.5 times, a difference (TD−MD) between the stretch ratio in the MD and the stretch ratio in the TD may be 0.1 or more, and the stretch ratio in the MD may be smaller than the stretch ratio in the TD.

In an exemplary embodiment, in the nylon film, a difference (TD−MD) between the stretch ratio in the MD and the stretch ratio in the TD may be 0.2 to 0.8 or 0.3 to 0.8.

In an exemplary embodiment, in the nylon film, a heat setting temperature after stretching the film may be 150 to 218° C., 160 to 218° C., 170 to 218° C., 180 to 218° C., 190 to 218° C., or 200 to 218° C. Preferably, in the nylon film, a heat setting temperature after stretching the film may be 160 to 215° C.

In an exemplary embodiment, the thickness of the outer layer is not particularly limited, but the outer layer may have a thickness of, for example, 10 μm to 50 μm, preferably 5 μm to 30 μm, and more preferably 10 μm to 25 μm.

In another aspect, a technology disclosed in the present provides a cell pouch including: a sealant layer; a metal layer formed on the sealant layer; and an outer layer formed on the metal layer, in which the outer layer includes a nylon film, and in the nylon film, a stretch ratio in the MD and a stretch ratio in the TD are each 2.8 times to 4.0 times, a difference (TD−MD) between the stretch ratio in the MD and the stretch ratio in the TD is 0.1 or more, and the stretch ratio in the MD is smaller than the stretch ratio in the TD.

In an exemplary embodiment, it may be preferred that the nylon film is manufactured with a stretch ratio in the MD and a stretch ratio in the TD each being 2.8 times to 4.0 times, 2.8 times to 3.8 times, 2.8 times to 3.5 times, 2.8 times to 3.3 times, 2.8 times to 3.0 times, 3.0 times to 4.0 times, 3.0 times to 3.8 times, 3.0 times to 3.5 times, 3.0 times to 3.3 times, 3.2 times to 4.0 times, 3.2 times to 3.8 times, or 3.2 times to 3.5 times in terms of improvement in formability of the cell pouch.

In an exemplary embodiment, in the nylon film, a difference (TD−MD) between the stretch ratio in the MD and the stretch ratio in the TD may be preferably 0.2 to 0.8 or 0.3 to 0.8 in terms of improvement in formability of the cell pouch.

In an exemplary embodiment, in the nylon film, a heat setting temperature after stretching the film may be 150 to 218° C., 160 to 218° C., 170 to 218° C., 180 to 218° C., 190 to 218° C., or 200 to 218° C. Preferably, in the nylon film, a heat setting temperature after stretching the film may be 160 to 215° C., or 200 to 215° C. in terms of improvement in formability of the cell pouch.

In still another aspect, a technology disclosed in the present specification provides a secondary battery including the cell pouch.

Hereinafter, the present disclosure will be described in more detail through Examples. These Examples are only for exemplifying the present disclosure, and it will be apparent to those of ordinary skill in the art that the scope of the present disclosure is not interpreted to be limited by them.

### Test Example 1. Tensile Test

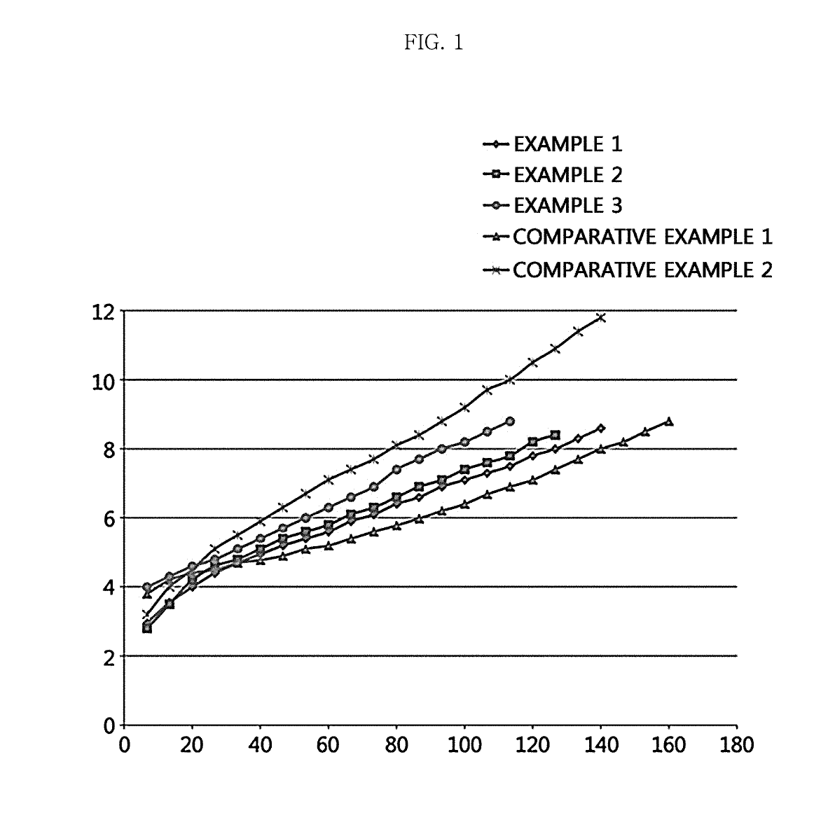

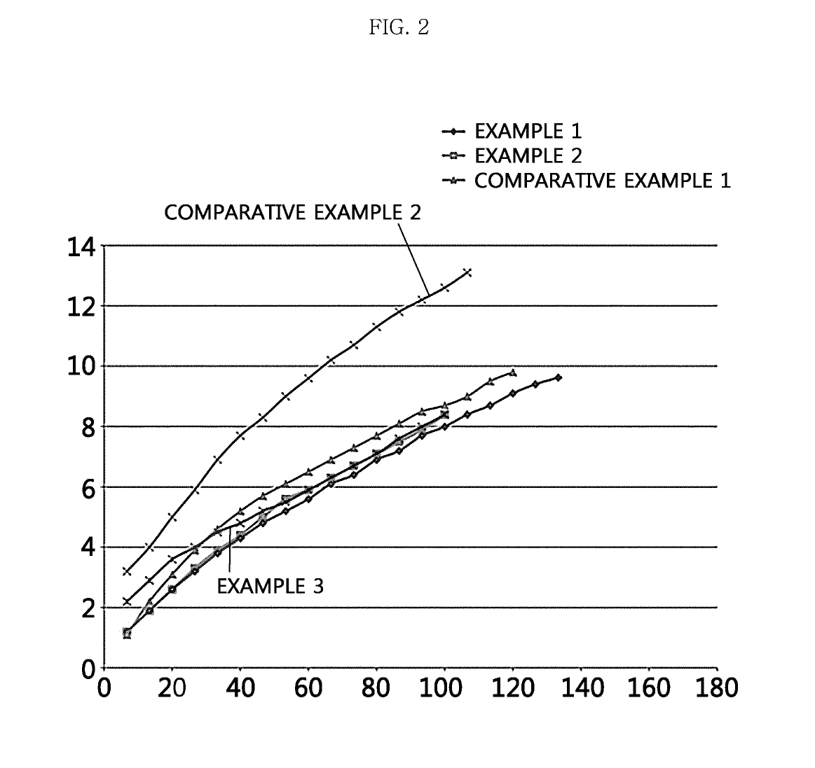

5 stretched nylon films were subjected to tensile test in the MD and TD. The tensile test was measured by making a sample with a width of 15 mm and using a tensile strength measuring apparatus (AGS-X model manufactured by SHIMADZU Corporation) under conditions of a distance between gauge marks of 30 mm, a measurement speed of 200 mm/min, and a load of 2 kg, and the results are shown in Tables 1 and 2 and FIGS. 1 and 2. In FIGS. 1 and 2, the x-axis and the y-axis mean the elongation (%) and the tensile strength (kgf), respectively.

TABLE 1
Tensile Strength (kgf) Value with respect to Elongation (%)
Value during Tensile Test in MD

| | | | | | Com- |
|---|---|---|---|---|---|
| | | | | Comparative | parative |
| Elongation | Example 1 | Example 2 | Example 3 | Example 1 | Example 2 |
| 6.7 | 2.95 | 2.8 | 4 | 3.8 | 3.2 |
| 13.3 | 3.55 | 3.5 | 4.3 | 4.2 | 4 |
| 20 | 4 | 4.2 | 4.6 | 4.4 | 4.5 |
| 26.6 | 4.4 | 4.6 | 4.8 | 4.5 | 5.1 |
| 33.3 | 4.7 | 4.8 | 5.1 | 4.7 | 5.5 |
| 40 | 4.95 | 5.1 | 5.4 | 4.78 | 5.9 |
| 46.6 | 5.2 | 5.4 | 5.7 | 4.9 | 6.3 |
| 53.3 | 5.4 | 5.6 | 6 | 5.1 | 6.7 |
| 60 | 5.6 | 5.8 | 6.3 | 5.2 | 7.1 |
| 66.6 | 5.9 | 6.1 | 6.6 | 5.4 | 7.4 |
| 73.3 | 6.1 | 6.3 | 6.9 | 5.6 | 7.7 |
| 80 | 6.4 | 6.6 | 7.4 | 5.78 | 8.1 |
| 86.6 | 6.6 | 6.9 | 7.7 | 5.98 | 8.4 |
| 93.3 | 6.9 | 7.1 | 8 | 6.2 | 8.8 |
| 100 | 7.1 | 7.4 | 8.2 | 6.4 | 9.2 |
| 106.6 | 7.3 | 7.6 | 8.5 | 6.68 | 9.7 |
| 113.3 | 7.5 | 7.8 | 8.8 | 6.9 | 10 |
| 120 | 7.8 | 8.2 | | 7.1 | 10.5 |
| 126.6 | 8 | 8.4 | | 7.4 | 10.9 |
| 133.3 | 8.3 | | | 7.7 | 11.4 |
| 140 | 8.6 | | | 8 | 11.8 |
| 146.6 | | | | 8.2 | |
| 153 | | | | 8.5 | |
| 160 | | | | 8.8 | |

The results of the tensile test in the MD are as follows. When the elongation (%) is defined as “x” and the tensile strength (kgf) is defined as “y”, in the case where a graph for a tensile strength value with respect to an elongation value during the stretch in the MD is “y=ax+b”, the slope “a” value was represented by an increment of a tensile strength value with respect to an increment of an elongation value (an increment of tensile strength/an increment of elongation) increasing from 6.7% to 100%, and the y intercept “b” value was represented by a value at an elongation of 6.7%. Specifically, the slope in Example 1, the slope in Example 2, the slope in Example 3, the slope in Comparative Example 1, and the slope in Comparative Example 2 were found to be 0.044, 0.049, 0.045, 0.029, and 0.064, respectively, and the width of change in elongation as compared to the tensile strength value was found to be constant.

TABLE 2
Tensile Strength (kgf) Value with respect to Elongation (%)
Value during Tensile Test in TD

| | | | | | Com- |
|---|---|---|---|---|---|
| | | | | Comparative | parative |
| Elongation | Example 1 | Example 2 | Example 3 | Example 1 | Example 2 |
| 6.7 | 1.2 | 1.2 | 2.2 | 1.1 | 3.2 |
| 13.3 | 1.9 | 1.9 | 2.9 | 2.2 | 4 |
| 20 | 2.6 | 2.6 | 3.6 | 3.1 | 5 |
| 26.6 | 3.2 | 3.3 | 4 | 3.9 | 5.9 |
| 33.3 | 3.8 | 3.9 | 4.5 | 4.6 | 6.9 |
| 40 | 4.3 | 4.4 | 4.8 | 5.2 | 7.7 |
| 46.6 | 4.8 | 5 | 5.2 | 5.7 | 8.3 |
| 53.3 | 5.2 | 5.6 | 5.5 | 6.1 | 9 |
| 60 | 5.6 | 5.9 | 5.9 | 6.5 | 9.6 |
| 66.6 | 6.1 | 6.3 | 6.3 | 6.9 | 10.2 |
| 73.3 | 6.4 | 6.7 | 6.7 | 7.3 | 10.7 |
| 80 | 6.9 | 7.1 | 7.1 | 7.7 | 11.3 |
| 86.6 | 7.2 | 7.5 | 7.6 | 8.1 | 11.8 |
| 93.3 | 7.7 | 7.9 | 8 | 8.5 | 12.2 |
| 100 | 8 | 8.4 | 8.4 | 8.7 | 12.6 |
| 106.6 | 8.4 | | | 9 | 13.1 |
| 113.3 | 8.7 | | | 9.5 | |
| 120 | 9.1 | | | 9.8 | |
| 126.6 | 9.4 | | | | |
| 133.3 | 9.62 | | | | |
| 140 | | | | | |
| 146.6 | | | | | |
| 153 | | | | | |
| 160 | | | | | |

The results of the tensile test in the TD are as follows. When the elongation (%) is defined as “x” and the tensile strength (kgf) is defined as “y”, in the case where a graph for a tensile strength value with respect to an elongation value during the stretch in the TD is “y=cx+d”, the slope “c” value was represented by an increment of a tensile strength value with respect to an increment of an elongation value (an increment of tensile strength/an increment of elongation) increasing from 6.7% to 100%, and the y intercept “b” value was represented by a value at an elongation of 6.7%. Specifically, the slope in Example 1, the slope in Example 2, the slope in Example 3, the slope in Comparative Example 1, and the slope in Comparative Example 2 were found to be 0.073, 0.077, 0.068, 0.081, and 0.1, respectively, the initial tensile strength starting value was found to be low, and the width of change in elongation as compared to the tensile strength value was found to be constant.

### Test Example 2. Formability Test (1) of Cell Pouch

In the present test example, the formabilities of the cell pouches were compared by applying the nylon films in the Examples and the Comparative Examples to the outer layers of the cell pouches.

The cell pouches were manufactured as follows. An aluminum (Al) thin film having a thickness of 40 μm was prepared as a metal layer, and a sealant layer was coated with a polypropylene-based resin on the metal layer so as to have a thickness of 45 μm at 180° C. And then, an outer layer was coated so as to have a thickness of 25 μm by using a nylon film on the other surface of the aluminum thin film. That is, a cell pouch having a flat shape was manufactured while not being molded into a laminated structure of a sealant layer/a metal layer/an outer layer.

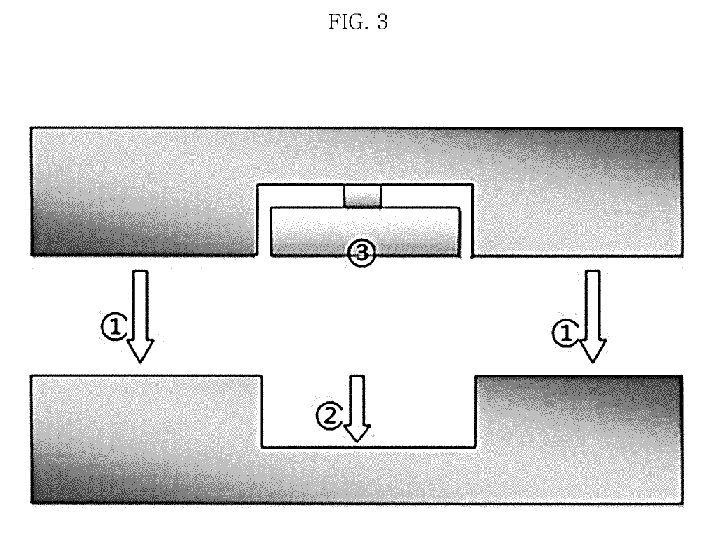

And then, each cell pouch sample manufactured above was cut into 15 cm×15 cm, and then was placed on a molding apparatus, and molded (molding apparatus speed 70 mm/min, main pressure 10 tons) by applying physical force thereto. Specifically, as shown in FIG. 3, the cell pouch was placed on a concavely dented portion of a mold of the molding apparatus, the No. 1 portion of the molding apparatus mold first came down to fix the pouch, and then the No. 3 portion came down to mold the cell pouch by means of physical pressure without heat. The change in molding depth of the cell pouch according to the nylon film is shown in the following Table 3. For the formability test, the same test was repeated five times, and the results with the maximum value and the minimum value thereof are shown.

TABLE 3

| | Formability of cell pouch |
|---|---|
| Example 1 | 6.4~7.6 mm |
| Example 2 | 6.2~6.9 mm |
| Example 3 | 6.0~6.5 mm |
| Comparative Example 1 | 5.3~5.7 mm |
| Comparative Example 2 | 5.4~6.2 mm |

As a result, during the stretch in the MD, a problem with the formability occurred when the increment of the tensile strength value with respect to the increment of the elongation value, that is, the slope “a” value was 0.04 or less or 0.05 or more. Likewise, during the stretch in the TD, a problem with the formability occurred when the increment of the tensile strength value with respect to the increment of the elongation value, that is, the slope “c” value was out of the range of more than 0.06 and less than 0.08.

Further, when the y intercept “b” value was 2<b<3 or 3.9<b<4.5 and the “d” value was 0.1<d<2 or 2<d<2.5 together with the range of the slope value, the y intercept value was so high that a problem in that cracks occurs was prevented due to the initial withstanding force during the molding, and a cell pouch was elongated even at a low force, and thus could be easily formed.

### Test Example 3. Formability Test (2) of Cell Pouch

In the present test example, Nylon-6 was stretched by varying the conditions in the stretch ratio in the MD and the TD as described in the following Table 4, and then was thermally fixed to manufacture a biaxially stretched nylon film.

TABLE 4

| | |
|---|---|
| | Heat setting temperature |
| Stretch ratio | after stretching (° C.) |

| | | | |
|---|---|---|---|
| Example 4 | MD 2.8 | TD 3.0 | 190~200 |
| Example 5 | MD 2.9 | TD 3.0 | 190~200 |
| Example 6 | MD 3.0 | TD 3.1 | 200~215 |
| Example 7 | MD 3.0 | TD 3.3 | 200~215 |
| Example 8 | MD 3.3 | TD 3.5 | 215~225 |
| Comparative | MD 2.2 | TD 2.2 | 190~200 |
| Example 3 | | | |
| Comparative | MD 2.2 | TD 2.5 | 190~200 |
| Example 4 | | | |
| Comparative | MD 2.5 | TD 2.6 | 180 |
| Example 5 | | | |

A cell pouch was manufactured by applying each nylon film manufactured above to an outer layer. Specifically, an aluminum (Al) thin film having a thickness of 40 μm was prepared as a metal layer, and a sealant layer was coated with a polypropylene-based resin on the metal layer so as to have a thickness of 45 μm at 180° C. And then, an outer layer was coated so as to have a thickness of 25 μm by using a nylon film on the other surface of the aluminum thin film. That is, a cell pouch having a flat shape was manufactured while not being molded into a laminated structure of a sealant layer/a metal layer/an outer layer.

And then, each cell pouch sample manufactured above was cut into 15 cm×15 cm, and then was placed on a molding apparatus, and molded (molding apparatus speed 70 mm/min, main pressure 10 tons) by applying physical force thereto. Specifically, as shown in FIG. 3, the cell pouch was placed on a concavely dented portion of a mold of the molding apparatus, the No. 1 portion of the molding apparatus mold first came down to fix the pouch, and then the No. 3 portion came down to mold the cell pouch by means of physical pressure without heat. The change in molding depth of the cell pouch according to the nylon film is shown in the following Table 5. For the formability test, the same test was repeated five times, and the results with the maximum value and the minimum value thereof are shown.

TABLE 5

| | Formability of cell pouch after applying stretch |
|---|---|
| Example 4 | 6.0~7.3 mm |
| Example 5 | 6.2~7.2 mm |
| Example 6 | 6.2~7.6 mm |
| Example 7 | 6.4~7.6 mm |
| Example 8 | 6.2~7.0 mm |
| Comparative Example 3 | 4.5~5.0 mm |
| Comparative Example 4 | 5.0~5.5 mm |
| Comparative Example 5 | 5.5~6.0 mm |

As a result, it could be seen that the high elongation nylon film significantly improved the formability of the cell pouch. In particular, when the stretch ratio in the MD was 2.8 times to 3.3 times and the stretch ratio in the TD was 3.0 times to 3.5 times, it could be confirmed that the formability of the cell pouch was significantly improved.

Although the specific part of the present disclosure has been described in detail, it will be apparent to those of ordinary skill in the art that such a specific description is just a preferred embodiment and the scope of the present disclosure is not limited thereby. Accordingly, the substantial scope of the present disclosure will be defined by the appended claims and equivalents thereof.

What is claimed is:

1. A cell pouch comprising:
a sealant layer;
a metal layer formed on the sealant layer; and
an outer layer formed on the metal layer,
wherein the outer layer comprises a nylon film, and
when the nylon film is subjected to a tensile test under conditions of a sample width of 15 mm, a distance between gauge marks of 30 mm, and a measurement speed of 200 mm/min, a graph for a tensile strength value with respect to an elongation value satisfies the following conditions in a case where an elongation (%) is defined as “x” and a tensile strength (kgf) is defined as “y”:
(i) when the film is stretched in a machine direction (MD), a slope “a” value, which is an increment of a tensile strength value with respect to an increment of an elongation value (an increment of tensile strength/an increment of elongation) increasing from 6.7% to 100%, is more than 0.04 and less than 0.05; and
(ii) when the film is stretched in a transverse direction (TD), a slope “c” value, which is an increment of a tensile strength value with respect to an increment of an elongation value (an increment of tensile strength/an increment of elongation) increasing from 6.7% to 100%, is more than 0.06 and less than 0.08.

2. The cell pouch according to claim 1, wherein the slope “a” value is 0.042≤a≤0.049.

3. The cell pouch according to claim 1, wherein the slope “a” value is 0.044≤a≤0.049.

4. The cell pouch according to claim 1, wherein the slope “c” value is 0.065≤a≤0.078.

5. The cell pouch according to claim 1, wherein the slope “c” value is 0.07≤a≤0.078.

6. The cell pouch according to claim 1, wherein when a graph of the tensile strength value with respect to the elongation value is “y=ax+b” during the stretch in the MD, a y intercept “b” value at an elongation of 6.7% is 2<b<3 or 3.9<b<4.5, and
when a graph of the tensile strength value with respect to the elongation value during the stretch in the TD is “y=cx+d”, a y intercept “d” value at an elongation of 6.7% is 0.1<d<2.5.

7. The cell pouch according to claim 6, wherein the y intercept “b” value is 2.5<b<3 or 3.9<b<4.3.

8. The cell pouch according to claim 6, wherein the y intercept “b” value is 2<b<3.

9. The cell pouch according to claim 6, wherein the y intercept “d” value is 0.5<d<2.5.

10. The cell pouch according to claim 6, wherein the y intercept “d” value is 0.5<d<1.5.

11. The cell pouch according to claim 1, wherein in the nylon film, a stretch ratio in the MD and a stretch ratio in the TD are each 2.8 times to 4.0 times, a difference between a stretch ratio in the MD and a stretch ratio in the TD is 0.1 or more, and the stretch ratio in the MD is smaller than the stretch ratio in the TD.

12. The cell pouch according to claim 11, wherein in the nylon film, the stretch ratio in the MD is 2.8 times to 3.3 times, and the stretch ratio in the TD is 3.0 times to 3.5 times.

13. The cell pouch according to claim 11, wherein in the nylon film, a difference between the stretch ratio in the MD and the stretch ratio in the TD is 0.2 to 0.8.

14. A cell pouch comprising:
a sealant layer;
a metal layer formed on the sealant layer; and
an outer layer formed on the metal layer,
wherein the outer layer comprises a nylon film, and
in the nylon film, a stretch ratio in the MD and a stretch ratio in the TD are each 2.8 times to 4.0 times, a difference between a stretch ratio in the MD and a stretch ratio in the TD is 0.1 or more, and the stretch ratio in the MD is smaller than the stretch ratio in the TD.

15. The cell pouch according to claim 14, wherein in the nylon film, the stretch ratio in the MD is 2.8 times to 3.3 times, and the stretch ratio in the TD is 3.0 times to 3.5 times.

16. The cell pouch according to claim 14, wherein in the nylon film, a difference between the stretch ratio in the MD and the stretch ratio in the TD is 0.2 to 0.8.

17. The cell pouch according to claim 14, wherein in the nylon film, a heat setting temperature after stretching the film is 150 to 218° C.

18. A secondary battery comprising the cell pouch according to claim 1.
